(19) United States
(12) Patent Application Publication
(10) Pub. No.: US 2026/0132772 A1
(43) Pub. Date: May 14, 2026

(54) PANORAMIC STITCHING METHOD FOR INFRARED IMAGES OF WIND TURBINE BLADE, DEVICE, STORAGE MEDIUM, AND PRODUCT

(71) Applicant: Hunan University, Changsha City (CN)

(72) Inventors: Ruizhen YANG, Changsha City (CN); Yunze HE, Changsha City (CN); Hongjin WANG, Changsha City (CN); Xiangyi LIU, Changsha City (CN); Qi CHEN, Changsha City (CN); Baoyuan DENG, Changsha City (CN); Yun ZHOU, Changsha City (CN); Yaonan WANG, Changsha City (CN)

(21) Appl. No.: 19/202,099

(22) Filed: May 8, 2025

(30) Foreign Application Priority Data
Nov. 11, 2024 (CN) 202411599454.5

(51) Int. Cl. F03D 17/00; G06F 17/16; G06T 7/38

(52) U.S. Cl. CPC F03D 17/003; F03D 17/004; F03D 17/028; G06T 7/38; G06F 17/16; G06T 2207/10048; G06T 2207/20212

(57) ABSTRACT

Provided are a panoramic stitching method for infrared images of a wind turbine blade, a device, a storage medium, and a product. The stitching method includes: performing coarse registration on each frame of visible image and infrared image; separately performing background subtraction on a coarsely-registered visible image and a coarsely-registered infrared image to obtain a foreground mask visible image, a foreground mask infrared image, a background-subtracted blade visible image, and a background-subtracted blade infrared image; performing fine registration on the foreground mask visible image and the foreground mask infrared image to obtain a relative displacement; stitching a plurality of frames of blade visible images to obtain a pixel increment; calculating a pixel increment when two adjacent frames of blade infrared images are stitched; and stitching two corresponding adjacent frames of background-subtracted blade infrared images, to obtain an infrared panoramic image of the wind turbine blade.

### CROSS REFERENCE TO RELATED APPLICATION

This patent application claims the benefit and priority of Chinese Patent Application No. 2024115994545.5, filed with the China National Intellectual Property Administration on Nov. 11, 2024, the disclosure of which is incorporated by reference herein in its entirety.

### TECHNICAL FIELD

The present disclosure belongs to the field of image processing technologies, and in particular, relates to a visible light-assisted and alignment-based panoramic stitching method for infrared images of a wind turbine blade, a device, a storage medium, and a product.

### BACKGROUND

As a critical component for harnessing wind energy, a wind turbine blade is prone to defects such as a crack, debonding, and a pit due to all-weather operation in a harsh natural environment and a complex climatic condition, thereby posing a significant safety hazard. A conventional inspection mainly relies on manual inspections such as a telescopic detection, a visual inspection during aerial rope-access circumnavigation, and maintenance platform check. These all have problems such as safety risks, low efficiency, and high subjectivity.

An unmanned aerial vehicle-based inspection of the wind turbine blade has become a globally prevalent practice. However, a length of the wind turbine blade is generally about 100 m, and consequently, an entire profile of the wind turbine blade cannot be captured by an unmanned aerial vehicle in a single flight operation. Therefore, in an inspection process, a camera needs to be continuously translated for a plurality of consecutive captures, to ensure full coverage of the wind turbine blade. In order to precisely analyze a location, an area, and an overall condition of a defect on the wind turbine blade, it is necessary to stitch images of the wind turbine blade captured by the unmanned aerial vehicle.

A conventional visible light inspection is limited to detecting a surface defect of an object. An infrared thermal imaging technology can achieve detection for defects and damages such as water ingress, delamination, and debonding in the wind turbine blade, and is of great practical significance. Unlike a visible image with distinct features, a high contrast, and clear textures, an acquired infrared image, constrained by hardware of an infrared detector, typically features a low resolution, a subtle grayscale difference value, sparse textural features, blurred blade edge details, and the like. It is difficult for a conventional visible image registration and stitching algorithm, for example, feature-based registration image stitching algorithm and an image grayscale matching-based image stitching method, to achieve a good stitching effect for infrared images of a wind turbine blade, and therefore, panoramic stitching for the infrared images of the wind turbine blade cannot be met.

### SUMMARY

An objective of the present disclosure is to provide a panoramic stitching method for infrared images of a wind turbine blade, a device, a storage medium, and a product. Due to a poor effect in the infrared image stitching field, a conventional visible image registration and stitching algorithm cannot be used to obtain a panoramic stitched image of the infrared images of the wind turbine blade.

To resolve the foregoing technical problems, the present disclosure provides the following technical solution: A panoramic stitching method for infrared images of a wind turbine blade includes:
obtaining a plurality of frames of visible images and infrared images of the wind turbine blade, where each frame of visible image corresponds to each frame of infrared image, and two adjacent frames of images overlap each other;
performing coarse registration on each frame of visible image and infrared image to obtain an infrared image that is coarsely registered with the visible image;
separately performing background subtraction on a coarsely-registered visible image and a coarsely-registered infrared image to obtain a foreground mask visible image, a foreground mask infrared image, a background-subtracted blade visible image, and a background-subtracted blade infrared image;
performing fine registration on the foreground mask visible image and the foreground mask infrared image to obtain a relative displacement during the fine registration between the foreground mask visible image and the foreground mask infrared image;
stitching a plurality of frames of background-subtracted blade visible images to obtain a pixel increment when two adjacent frames of blade visible images are stitched;
calculating, based on the relative displacement and the pixel increment when two adjacent frames of blade visible images are stitched, a pixel increment when two corresponding adjacent frames of blade infrared images are stitched; and
stitching, based on the pixel increment when two adjacent frames of blade infrared images are stitched, two corresponding adjacent frames of background-subtracted blade infrared images, to obtain an infrared panoramic image of the wind turbine blade.

Before the obtaining a plurality of frames of visible images and infrared images of the wind turbine blade, the method includes: adopting a Zhang's calibration method to separately perform monocular calibration on a visible light camera configured to acquire a visible image and an infrared thermal imaging camera configured to acquire an infrared image, to obtain an intrinsic matrix of the visible light camera, an intrinsic matrix of the infrared thermal imaging camera, a distortion correction parameter of the visible image, and a distortion correction parameter of the infrared image.

Further, the obtaining a plurality of frames of visible images and infrared images of the wind turbine blade is specifically implemented as follows:
locking a to-be-inspected wind turbine blade; and
carrying a visible light camera and an infrared thermal imaging camera on an unmanned aerial vehicle, and controlling the unmanned aerial vehicle to perform rectilinear flight and acquire an image along a single blade and in parallel to a blade surface.

Further, the performing coarse registration on each frame of visible image and infrared image includes:
performing an un-distortion operation on the visible image based on an intrinsic matrix of a calibrated visible light camera and a distortion correction parameter of the visible image;
performing an un-distortion operation on the infrared image based on an intrinsic matrix of a calibrated infrared thermal imaging camera and a distortion correction parameter of the infrared image;
calculating a registration transformation matrix and an offset based on an undistorted visible image and an undistorted infrared image, where a calculation formula for the registration transformation matrix is as follows:

$${R}_{C} = [ \begin{matrix}{δ}_{s} & 0 \\ 0 & {δ}_{s}\end{matrix} ] , {δ}_{s} = \frac{{B}_{i}^{V} - {B}_{i - 1}^{V}}{{B}_{i}^{l} - {B}_{i - 1}^{l}} ,$$

where
R_{C} represents the registration transformation matrix, δₛ represents a scaling factor,

$${B}_{i}^{V} and {B}_{i - 1}^{V}$$

respectively represent coordinates, in a horizontal direction or a vertical direction of the visible image, of centers of two adjacent black squares i and i−1 in a chessboard calibration board, and

$${B}_{i}^{I} and {B}_{i - 1}^{I}$$

respectively represent coordinates, in a horizontal direction or a vertical direction of the infrared image, of the centers of the two adjacent black squares i and i−1 in the chessboard calibration board; and the chessboard calibration board is located in front of the visible light camera and the infrared thermal imaging camera;
a calculation formula for the offset is as follows:

$${x}_{d} = {x}_{vis} - {x}_{inf} , {y}_{d} = {y}_{vis} - {y}_{inf} ,$$

where
x_{d} and y_{d} represent offsets of the infrared image in the horizontal direction and the vertical direction, and (xᵥᵢₛ, yᵥᵢₛ) and (x_{inf}, y_{inf}) respectively represent pixel coordinates, in, the visible image and the infrared image, of a center of any square in the chessboard calibration board; and
calculating, based on the registration transformation matrix and the offset, the infrared image that is coarsely registered with the visible image, and a specific formula is as follows:

$$[ \begin{matrix}{Inf}_{ix}^{′} \\ {Inf}_{iy}^{′}\end{matrix} ] = [ \begin{matrix}{δ}_{s} & 0 \\ 0 & {δ}_{s}\end{matrix} ] [ \begin{matrix}{Inf}_{ix} \\ {Inf}_{iy}\end{matrix} ] + [ \begin{matrix}{x}_{d} \\ {y}_{d}\end{matrix} ] ,$$

where
(Infᵢₓ, Inf_{iy}) represents pixel coordinates of the undistorted infrared image, and

$$( {Inf}_{ix}^{′} , {Inf}^{′} )$$

represents pixel coordinates of the infrared image that is coarsely registered with the visible image.

Further, the separately performing background subtraction on a coarsely-registered visible image and a coarsely-registered infrared image includes:
separately performing background segmentation on the coarsely-registered visible image and the coarsely-registered infrared image to obtain the foreground mask visible image and the foreground mask infrared image;
separately performing an edge contour smoothing operation on the foreground mask visible image and the foreground mask infrared image; and
separately setting foreground RGB channel pixels of a smoothed foreground mask visible image to 1, and then multiplying the smoothed foreground mask visible image with the foreground RGB channel pixel set to 1 with the visible image to obtain the background-subtracted blade visible image; and separately setting foreground RGB channel pixels of a smoothed foreground mask infrared image to 1, and then multiplying the smoothed foreground mask infrared image with the foreground RGB channel pixel set to 1 with the coarsely-registered infrared image to obtain the background-subtracted blade infrared image.

Further, the performing fine registration on the foreground mask visible image and the foreground mask infrared image includes:
separately performing edge detection on the foreground mask visible image and the foreground mask infrared image to obtain a blade edge visible image and a blade edge infrared image;
separately performing boundary extraction on the blade edge visible image and the blade edge infrared image to obtain a first boundary coordinate list and a second boundary coordinate list, where the first boundary coordinate list is a boundary coordinate list of the blade edge visible image, and the second boundary coordinate list is a boundary coordinate list of the blade edge infrared image;
calculating a first width information list based on the first boundary coordinate list, and calculating a second width information list based on the second boundary coordinate list; and
calculating, based on the first width information list and the second width information list, the relative displacement during the fine registration between the foreground mask visible image and the foreground mask infrared image, where a specific calculation formula is as follows:

$${h}_{k} = {y}_{i}^{″} , {y}_{i}^{″} ← min \vert {w}_{i}^{″} - {w}_{0}^{″} \vert ,$$

where
hₖ represents a relative displacement during fine registration between a k^{th} frame of foreground mask visible image and foreground mask infrared image,

$${W}_{0}^{′}$$

represents a width of an uppermost part in the first width information list,

$${W}_{i}^{″}$$

represents a width of an i^{th} row in the second width information list, and

$${y}_{i}^{″}$$

represents a vertical coordinate of an i^{th} row in the second width information list.

Further, a specific calculation formula for the pixel increment when two adjacent frames of blade infrared images are stitched is as follows:

$${P}_{k , k - 1} = {Q}_{k , k - 1} + ( {h}_{k} - {h}_{k - 1} ) ,$$

where
P_{k,k-1} represents a pixel increment when a k^{th} frame of background-subtracted blade infrared image and a k−1^{th} frame of background-subtracted blade infrared image are stitched; Q_{k,k-1} represents a pixel increment when a k^{th} frame of background-subtracted blade visible image and a k−1^{th} frame of background-subtracted blade visible image are stitched; hₖ represents the relative displacement during fine registration between the k^{th} frame of foreground mask visible image and foreground mask infrared image, and hₖ₋₁ represents a relative displacement between a k−1^{th} frame of foreground mask visible image and foreground mask infrared image.

Based on a same concept, the present disclosure further provides an electronic device, including a memory, a processor, and a computer program/instruction stored on the memory, where the processor executes the computer program/instruction to implement the panoramic stitching method for infrared images of a wind turbine blade.

Based on a same concept, the present disclosure further provides a computer-readable storage medium on which a computer program/instruction is stored, where when the computer program/instruction is executed by a processor, the panoramic stitching method for infrared images of a wind turbine blade is implemented.

Based on a same concept, the present disclosure further provides a computer program product, including a computer program/instruction, where when the computer program/instruction is executed by a processor, the panoramic stitching method for infrared images of a wind turbine blade is implemented.

### Beneficial Effects are as Follows:

Compared with the prior art, the present disclosure has the following advantages:

According to the present disclosure, through a registration operation between heterogeneous images, the infrared images of the wind turbine blade are stitched by stitching visible images of the wind turbine blade based on richer grayscale feature information, and the problems of a low resolution, sparse features, blurred details, and difficulty in stitching the infrared images of the wind turbine blade are resolved. In addition, the present disclosure can effectively achieve stitching infrared thermal images of a wind turbine blade with sparser texture features, and stitching results are stable and reliable.

### BRIEF DESCRIPTION OF THE DRAWINGS

To describe the technical solutions in the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a flowchart of a panoramic stitching method for infrared images of a wind turbine blade according to an embodiment of the present disclosure;

FIG. 2 is a schematic diagram of acquisition of a visible image and an infrared image according to an embodiment of the present disclosure, where UAV represents unmanned aerial vehicle;

FIG. 3 is a schematic diagram of a coarse registration process according to an embodiment of the present disclosure;

FIGS. 4A-4C are schematic diagrams of an effect of performing background subtraction on a visible image according to an embodiment of the present disclosure;

FIGS. 5A-5C are schematic diagrams of an effect of performing background subtraction on an infrared image according to an embodiment of the present disclosure;

FIG. 6 is a schematic diagram of fine registration according to an embodiment of the present disclosure;

FIG. 7 is a schematic diagram of an effect of stitching visible images according to an embodiment of the present disclosure;

FIG. 8 is a schematic diagram of an effect of stitching infrared images according to an embodiment of the present disclosure; and

FIG. 9 shows an infrared panoramic image of a wind turbine blade according to an embodiment of the present disclosure.

### DETAILED DESCRIPTION OF THE EMBODIMENTS

The following clearly and completely describes the technical solution of the present disclosure with reference to the accompanying drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts shall fall within the scope of protection of the present disclosure.

The technical solution of the present disclosure will be described in detail below with reference to specific embodiments. The following specific embodiments may be combined with each other, and the same or similar concepts or processes may not be repeatedly described in some embodiments.

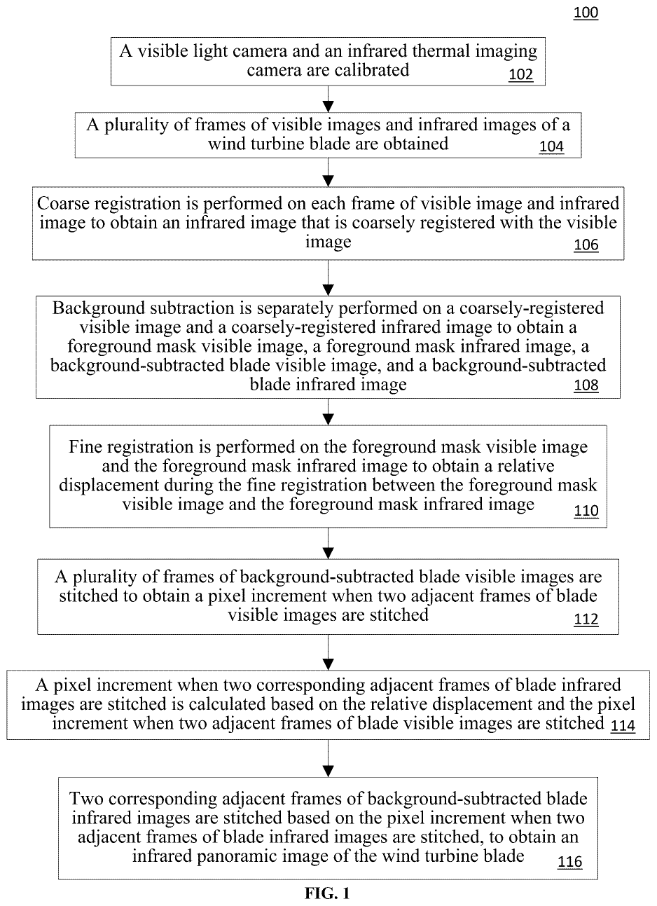

As shown in FIG. 1, a panoramic stitching method for infrared images of a wind turbine blade according to an embodiment of the present disclosure includes the following steps.

In step 1, as shown at block 102, a visible light camera and an infrared thermal imaging camera are calibrated.

The visible light camera is configured to acquire a visible image of the wind turbine blade, and the infrared thermal imaging camera is configured to acquire an infrared image of the wind turbine blade. Before dual-spectral images (namely, the visible image and the infrared image) of the wind turbine blade are acquired, monocular calibration is separately performed on the visible light camera and the infrared thermal imaging camera by using a Zhang's calibration method. A specific calibration process is performed on OpenCV as follows: Several images of a chessboard calibration board are respectively taken from different perspectives; then, chessboard corners are determined and found from the images by utilizing the findChessboardCorners function; then, coordinates of each corner of the chessboard calibration board are further determined by using the cornerSubPix function; and finally, an intrinsic matrix of the visible light camera, an intrinsic matrix of the infrared thermal imaging camera, a distortion correction parameter of the visible image, and a distortion correction parameter of the infrared image are separately calculated by calling the calibrateCamera function.

Due to different locations and focal lengths of lenses of the visible light camera and the infrared thermal imaging camera, an image size and a location of a spatial object shot by the two lenses are also different. Therefore, the chessboard calibration board is placed in front of the two cameras, and the two cameras are ensured to capture a complete calibration board image during imaging. Image sizes of squares on the calibration board and a relative distance between the two adjacent black squares on the calibration board are obtained through calibration to subsequently calculate a coordinate mapping relationship for coarse registration and alignment between heterogeneous images, namely, a coarse registration transformation matrix R_{C}.

In step 2, as shown at block 104, a plurality of frames of visible images and infrared images of the wind turbine blade are obtained.

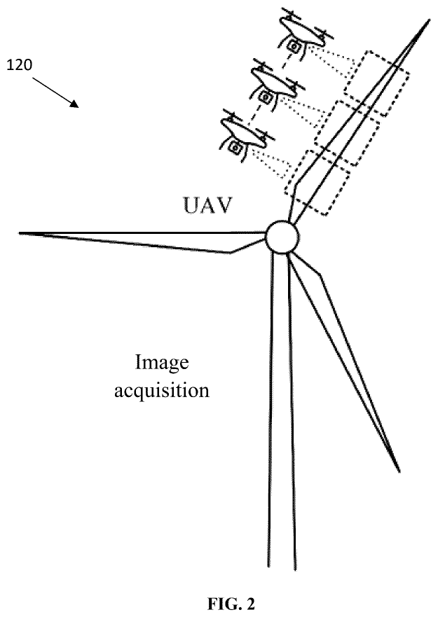

In the present disclosure, the visible light camera and the infrared thermal imaging camera are carried on an unmanned aerial vehicle to capture the visible image and the infrared image of the wind turbine blade. As shown in FIG. 2, before image acquisition, a to-be-inspected wind turbine blade is firstly locked, and then the unmanned aerial vehicle is controlled to perform rectilinear flight and acquire an image along a single blade and in parallel to a blade surface. Images may be sequentially captured from a root to a tip of the wind turbine blade or images may be sequentially captured from a tip to a root of the wind turbine blade. The visible light camera and the infrared thermal imaging camera are configured to simultaneously acquire images at a same time interval. Therefore, each frame of image includes one frame of visible image and one frame of infrared image. A same frame of visible image and infrared image corresponds to a same part of the wind turbine blade. Two adjacent frames of images overlap each other, to facilitate stitching and ensure integrity of stitched images.

To simplify a track control solution of the unmanned aerial vehicle, the to-be-inspected wind turbine blade is firstly locked in a vertically downward direction, then a pitch angle of the unmanned aerial vehicle is adjusted to keep the pitch angle of the unmanned aerial vehicle at 0°, and then, the unmanned aerial vehicle is controlled to perform rectilinear flight and acquire an image in a direction perpendicular to the ground.

In step 3, as depicted at block 1-6, coarse registration is performed on each frame of visible image and infrared image to obtain an infrared image that is coarsely registered with the visible image.

The coarse registration in step 3, background subtraction in step 4 (see block 108), and a fine registration operation in step 5 (see block 110) are performed on both each frame of visible image and infrared image. In a specific implementation of the present disclosure, that coarse registration is performed on each frame of visible image and infrared image includes the following steps.

In step 3.1, an un-distortion operation is performed on the visible image based on an intrinsic matrix of the visible light camera calibrated in step 1 and a distortion correction parameter of the visible image.

In step 3.2, an un-distortion operation is performed on the infrared image based on an intrinsic matrix of the infrared thermal imaging camera calibrated in step 1 and a distortion correction parameter of the infrared image, where the un-distortion operation can be implemented by calling the undistort function in OpenCV.

In step 3.3, a registration transformation matrix and an offset are calculated based on an undistorted visible image and an undistorted infrared image, where a calculation formula for the registration transformation matrix is as follows:

$${R}_{C} = [ \begin{matrix}{δ}_{s} & 0 \\ 0 & {δ}_{s}\end{matrix} ] \qquad ( 1 )$$

$${δ}_{s} = \frac{{B}_{i}^{V} - {B}_{i - 1}^{V}}{{B}_{i}^{l} - {B}_{i - 1}^{l}} , \qquad ( 2 )$$

where
R_{C} represents the registration transformation matrix, δₛ represents a scaling factor,

$${B}_{i}^{V} and {B}_{i - 1}^{V}$$

respectively represent coordinates, in a horizontal direction or a vertical direction of the visible image, of centers of two adjacent black squares i and i−1 in a chessboard calibration board, and

$${B}_{i}^{l} and {B}_{i - 1}^{l}$$

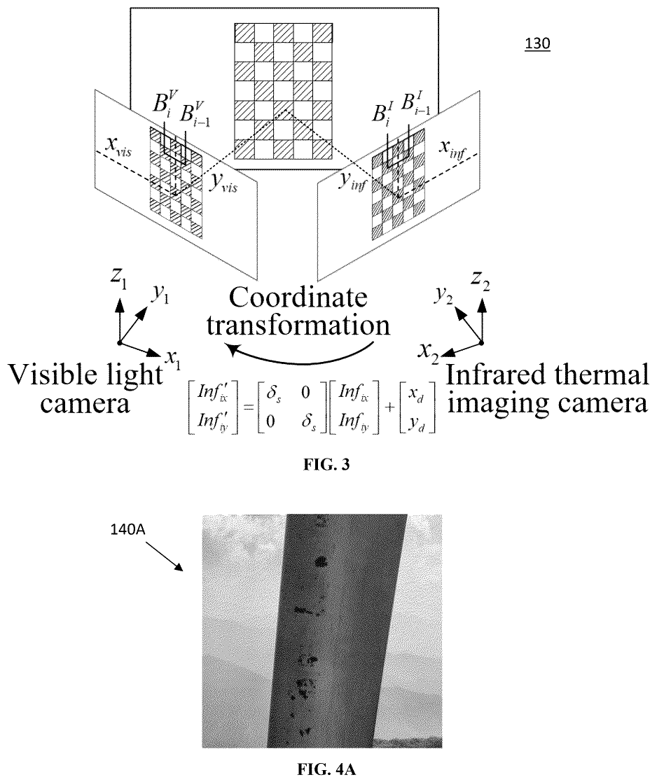

respectively represent coordinates, in a horizontal direction or a vertical direction of the infrared image, of the centers of the two adjacent black squares i and i−1 in the chessboard calibration board, as shown in FIG. 3. The registration transformation matrix R_{C} is obtained through calculation based on image sizes of the chessboard calibration board in the visible light camera and the infrared thermal imaging camera, and a relative distance between the two adjacent black squares on the calibration board. Before the registration transformation matrix is obtained through calculation, the scaling factor δₛ is first calculated based on a pixel difference between coordinates, in the visible image and the infrared image, of centers of any two adjacent black squares in the chessboard calibration board.

There is a specific relative offset between the visible image and the infrared image. Therefore, an image offset further needs to be calculated based on pixel coordinate locations, in the visible image and the infrared image, of a center of any square in the chessboard calibration board. A specific calculation formula for the offset is as follows:

$${x}_{d} = {x}_{vis} - {x}_{inf} \qquad ( 3 )$$

$${y}_{d} = {y}_{vis} - {y}_{inf} , \qquad ( 4 )$$

where
x_{d} and y_{d} represent offsets of the infrared image in the horizontal direction and the vertical direction, and (xᵥᵢₛ, yᵥᵢₛ) and (x_{inf}, y_{inf}) respectively represent pixel coordinates, in the visible image and the infrared image, of a center of any square in the chessboard calibration board.

In step 3.4, the infrared image that is coarsely registered with the visible image is calculated based on the registration transformation matrix and the offset, to implement coarse registration between the visible image and the infrared image.

In this embodiment, a specific formula for calculating the infrared image that is coarsely registered with the visible image as follows:

$$[ \begin{matrix}{Inf}_{ix}^{′} \\ {Inf}_{iy}^{′}\end{matrix} ] = [ \begin{matrix}{δ}_{s} & 0 \\ 0 & {δ}_{s}\end{matrix} ] [ \begin{matrix}{Inf}_{ix} \\ {Inf}_{iy}\end{matrix} ] + [ \begin{matrix}{x}_{d} \\ {y}_{d}\end{matrix} ] , \qquad ( 5 )$$

where
(Infᵢₓ, Inf_{iy}) represents pixel coordinates of the undistorted infrared image, and

$$( {Inf}_{ix}^{′} , {Inf}^{′} )$$

represents pixel coordinates of the infrared image that is coarsely registered with the visible image.

In step 4, background subtraction is separately performed on a coarsely-registered visible image and a coarsely-registered infrared image to obtain a foreground mask visible image, a foreground mask infrared image, a background-subtracted blade visible image, and a background-subtracted blade infrared image.

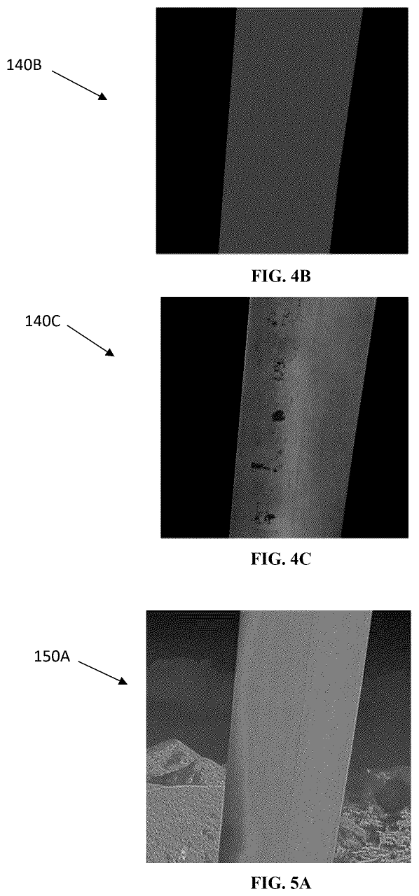

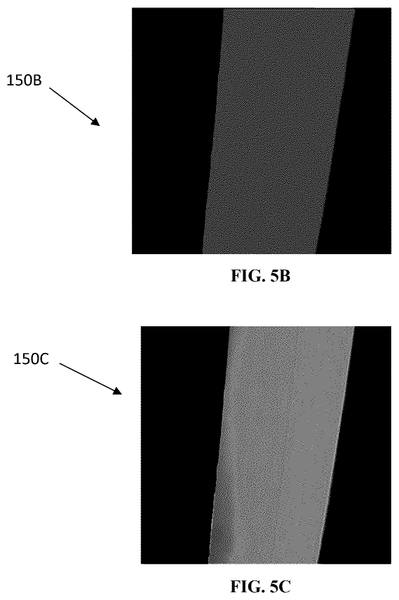

As shown in FIGS. 4A-4C and FIGS. 5A-5C, images 140A, 140B, 140C, 150A, 150B, and 150C of the wind turbine blade shot by the visible light camera and the infrared thermal imaging camera includes a great deal of background information. Complex background information affects a subsequent stitching result, and therefore, a background subtraction operation needs to be separately performed on the visible image and the infrared image. In a specific implementation of the present disclosure, that background subtraction is separately performed on the coarsely-registered visible image and the coarsely-registered infrared image includes the following steps.

In step 4.1, background segmentation is separately performed on the coarsely-registered visible image and the coarsely-registered infrared image to obtain a foreground mask visible image A and a foreground mask infrared image B.

In step 4.2, an edge contour smoothing operation is separately performed on the foreground mask visible image A and the foreground mask infrared image B.

In step 4.3, foreground RGB channel pixels of a smoothed foreground mask visible image are separately set to 1, and then the smoothed foreground mask visible image with the foreground RGB channel pixel set to 1 is multiplied with the visible image, making a pixel value of a blade part in the visible image be kept to the original value, to obtain a background-subtracted blade visible image, as shown in FIGS. 4A-4C.

In step 4.4, foreground RGB channel pixels of a smoothed foreground mask infrared image are separately set to 1, and then the smoothed foreground mask infrared image with the foreground RGB channel pixel set to 1 is multiplied with the coarsely-registered infrared image, making a pixel value of a blade part in the infrared image be kept to the original value, to obtain a background-subtracted blade infrared image, as shown in FIGS. 5A-5C.

In this embodiment, background segmentation is separately performed on the coarsely-registered visible image and the coarsely-registered infrared image by using a U-net network. The U-net network is an effective semantic segmentation framework. Before the background segmentation is performed on the coarsely-registered visible image and the coarsely-registered infrared image by using the U-net network, a training sample dataset needs to be first constructed to train the U-net network. The training sample dataset includes a plurality of samples, and each sample includes the coarsely-registered infrared image and a label thereof or the coarsely-registered visible image and a label thereof. Pixel-level labels may be obtained by annotating both the coarsely-registered visible image and the coarsely-registered infrared image by using Labelme software.

To ensure smooth and natural edge contours of the foreground mask visible image A and the foreground mask infrared image B that are obtained through background segmentation, small gaps between the foreground mask visible image A and an image border further need to be eliminated. A 7×7 full-one matrix serves as a structuring element for a closing operation to perform a morphological closing operation in which dilation is followed by erosion on the foreground mask visible image A to fill and connect gaps on an edge of the image. In this way, narrow interruptions and elongated gullies between the foreground mask visible image A and the image border are bridged, to make transition along boundaries of the wind turbine blade be more natural. Similarly, the morphological closing operation in which dilation is followed by erosion is also performed on the foreground mask infrared image B.

In step 5, as shown at block 110 in FIG. 1, fine registration is performed on the foreground mask visible image and the foreground mask infrared image to obtain a relative displacement during the fine registration between the foreground mask visible image and the foreground mask infrared image.

According to the present disclosure, fine registration for dual-spectral images is implemented by searching for and matching blade width information in the foreground mask visible image and the foreground mask infrared image. In a specific implementation of the present disclosure, that fine registration is performed on the foreground mask visible image and the foreground mask infrared image includes the following steps.

In step 5.1, edge detection is separately performed on the foreground mask visible image and the foreground mask infrared image to obtain a blade edge visible image and a blade edge infrared image.

In this embodiment, the edge detection is separately performed on the foreground mask visible image and the foreground mask infrared image by using a Canny edge detector, and specifically includes: calculating a gradient magnitude and a direction of an image pixel after smoothing an image using Gaussian filtering. Specifically, convolution with an input image (namely, the foreground mask visible image or the foreground mask infrared image) is separately performed by using a Sobel horizontal operator Sₓ and a vertical operator S_{y}, to calculate a gradient magnitude Eₓ and a direction E_{y} of each pixel point in the horizontal direction and the vertical direction, so as to further calculate a gradient magnitude E and a direction θ of each pixel point of the image according to the following specific formulas:

$${S}_{x} = [ \begin{matrix}- 1 & 0 & 1 \\ - 2 & 0 & 2 \\ - 1 & 0 & 1\end{matrix} ] \qquad ( 6 )$$

$${S}_{y} = [ \begin{matrix}- 1 & - 2 & - 1 \\ 0 & 0 & 0 \\ 1 & 2 & 1\end{matrix} ] \qquad ( 7 )$$

$${E}_{x} = f ( x , y ) * {S}_{x} \qquad ( 8 )$$

$${E}_{y} = f ( x , y ) * {S}_{y} \qquad ( 9 )$$

$$E = \sqrt{{E}_{x}^{2} + {E}_{y}^{2}} \qquad ( 10 )$$

$$θ = arctan ( {E}_{y} / {E}_{x} ) , \qquad ( 11 )$$

where
f(x, y) represents an image area covered by a convolution kernel centered at a point (x, y) during calculation of a gradient of each pixel point through convolution.

Non-edge pixels are filtered out through non-maximum suppression from an image obtained through the edge detection, then, spurious edges are eliminated through double-threshold detection, and finally, edges are connected to obtain a complete blade edge image, that is, a blade edge visible image A′ and a blade edge infrared image B′ are separately obtained.

In step 5.2, boundary extraction is separately performed on the blade edge visible image and the blade edge infrared image to obtain a first boundary coordinate list and a second boundary coordinate list, where the first boundary coordinate list is a boundary coordinate list of the blade edge visible image, and the second boundary coordinate list is a boundary coordinate list of the blade edge infrared image.

For the blade edge visible image A′, with the top-left corner of the image as the origin, the horizontal direction as the X-axis, and the vertical direction as the Y-axis, the image is traversed to obtain points where a pixel value is not zero, and coordinates and corresponding pixel values of the points are stored in a list. The coordinates of the points in the list are judged. If a distance between any two points on each row in the list is less than a pixel threshold (for example, 3 pixels), the two points are considered to be from a same boundary. Otherwise, the two points belong to different boundaries, and the two points are respectively left and right edge points on the corresponding row. In this way, all left and right edge points on each row of the blade are obtained. On each row, coordinates of a point with a maximum pixel value in all points on left and right edges of the blade are respectively obtained, to obtain the first boundary coordinate list, recorded as follows:

$${L}_{1} = [ [ {y}_{0} , {x}_{0 l} , {x}_{0 r} ] , [ {y}_{1} , {x}_{1 l} , {x}_{1 r} ] , … , [ {y}_{i} , {x}_{il} , {x}_{i r} ] , … , [ {y}_{N} , {x}_{Nl} , {x}_{N r} ] ] , \qquad ( 12 )$$

where
L₁ represents the first boundary coordinate list, xᵢₗ represents a horizontal coordinate of a point with a maximum pixel value on the left edge of an i^{th} row of the blade, x_{if} represents a horizontal coordinate of a point with a maximum pixel value on the right edge of the i^{th} row of the blade, yᵢ represents vertical coordinates (namely, a vertical coordinate of the point with the maximum pixel value on the left edge of the i^{th} row and the point with maximum pixel value on the right edge of the i^{th} row) corresponding to xᵢₗ and xᵢᵣ, and N represents a sequence number of a last row, N+1 rows in total. Points with same vertical coordinates in the image form one row, that is, vertical coordinates of pixel points in each row are the same and are not zero.

Similarly, for the blade edge infrared image B′, the second boundary coordinate list L₂ may be obtained.

In step 5.3, a first width information list is calculated based on the first boundary coordinate list, and a second width information list is calculated based on the second boundary coordinate list.

A blade width on each row is calculated based on the first boundary coordinate list L₁ or the second boundary coordinate list L₂ by using a width calculation formula Wᵢ=Xᵢᵣ−Xᵢₗ. In this way, a first width information list

$${L}_{vis} = [ [ {y}_{0}^{′} , {w}_{0}^{′} ] , [ {y}_{1}^{′} , {w}_{1}^{′} ] … [ {y}_{i}^{′} , {w}_{i}^{′} ] … [ {y}_{N}^{′} , {w}_{N}^{′} ] ]$$

and a second width information list

$${L}_{inf} = [ [ {y}_{0}^{″} , {w}_{0}^{″} ] , [ {y}_{1}^{″} , {w}_{1}^{″} ] … [ {y}_{i}^{″} , {w}_{i}^{″} ] … [ {y}_{N}^{″} , {w}_{N}^{″} ] ]$$

are obtained, where

$${y}_{i}^{′} and {y}_{i}^{″}$$

respectively represent vertical coordinates on the i^{th} row in the blade edge visible image A′ and the blade edge infrared image B′, and

$${w}_{i}^{′} and {w}_{i}^{″}$$

respectively represent widths on the i^{th} row in the blade edge visible image A′ and the blade edge infrared image B′.

In step 5.4, a relative displacement during fine registration between the foreground mask visible image A and the foreground mask infrared image B is calculated based on the first width information list and the second width information list.

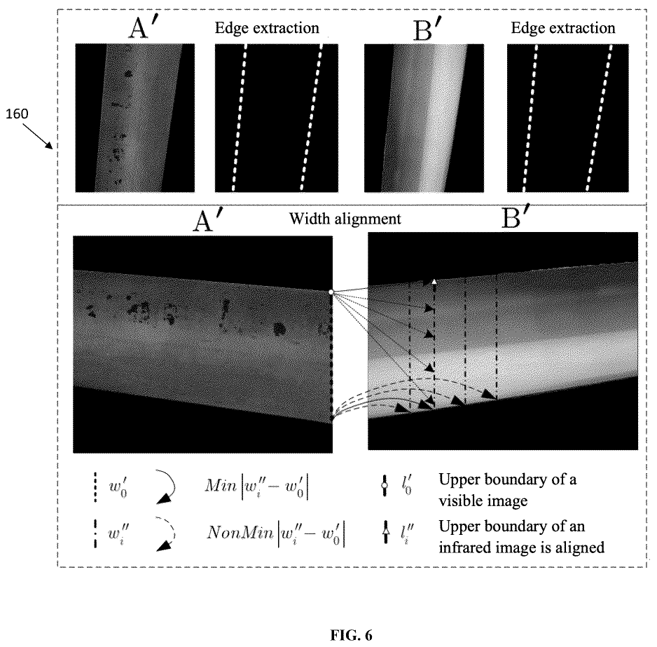

As shown in the configuration 160 of FIG. 6, the second width information list L_{inf} is traversed based on a width (namely, a width on the first row, where a vertical coordinate on the first row is zero)

$${w}_{0}^{′}$$

on the topmost part in the first width information list Lᵥᵢₛ, to obtain a vertical coordinate on the i^{th} row of the corresponding blade edge infrared image B′ when a width on the row is closest to

$${w}_{0}^{′} .$$

In this case, the vertical coordinate on the row is the relative displacement of the blade edge infrared image B′ relative to the blade edge visible image A′ during fine registration, and a specific calculation formula is as follows:

$${h}_{k} = {y}_{i}^{″} , {y}_{i}^{″} ← min \vert {w}_{i}^{″} - {w}_{0}^{′} \vert , \qquad ( 13 )$$

where
hₖ represents a relative displacement during fine registration between a k^{th} frame of foreground mask visible image and foreground mask infrared image;

$${w}_{0}^{′}$$

represents a width of an uppermost part (namely, the first row) in the first width information list;

$${w}_{i}^{″}$$

represents a width of an i^{th} row in the second width information list, where the width

$${w}_{i}^{″}$$

of the row is closest to

$${w}_{0}^{′} ; {y}_{i}^{″}$$

represents vertical coordinates of an i^{th} row in the second width information list, namely, the vertical coordinate of the row corresponding to the width

$${w}_{i}^{″}$$

in the second width information list.

For each frame of foreground mask infrared image (or each frame of infrared image), there is one relative displacement hₖ.

In step 6, as shown at block 112 in FIG. 1, a plurality of frames of background-subtracted blade visible images are stitched to obtain a pixel increment when two adjacent frames of blade visible images are stitched.

In a specific implementation of the present disclosure, the plurality of frames of background-subtracted blade visible images are stitched by using a normalized cross-correlation (NCC) algorithm for grayscale images. The normalized cross-correlation (NCC) algorithm for grayscale images is the existing technology, and a principle thereof is as follows: Two adjacent frames of images are matched to obtain an optimal matching location, and the two adjacent frames of images are stitched and synthesized based on the optimal matching location. The NCC algorithm is used to obtain a similarity between a template image and a to-be-searched image at different locations by using an evaluation function, and a location with a greatest similarity is the optimal matching location. A calculation formula for the similarity is as follows:

$$ρ ( i , j ) = \frac{{\sum }_{m = 1}^{m} {\sum }_{n = 1}^{n} {S}^{i , j} ( m , n ) T ( m , n ) - mn \overline{T} \overline{{S}^{i , j}}}{\sqrt{{\sum }_{m = 1}^{m} {\sum }_{n = 1}^{n} {( {S}^{i , j} ( m , n ) )}^{2} - mn {\overline{{S}^{i , j}}}^{2}} \sqrt{{\sum }_{m = 1}^{m} {\sum }_{n = 1}^{n} {( T ( m , n ) )}^{2} - mn {\overline{T}}^{2}}} , \qquad ( 14 )$$

where
T(m,n) represents the template image, S^{i,j} represents a sub-image, covered by the to-be-searched image, of the template image, m and n respectively represent a width and a height of the template image, and T̅ and \sqrt{S^{i,j}} respectively represent grey average values of the template image and the sub-image.

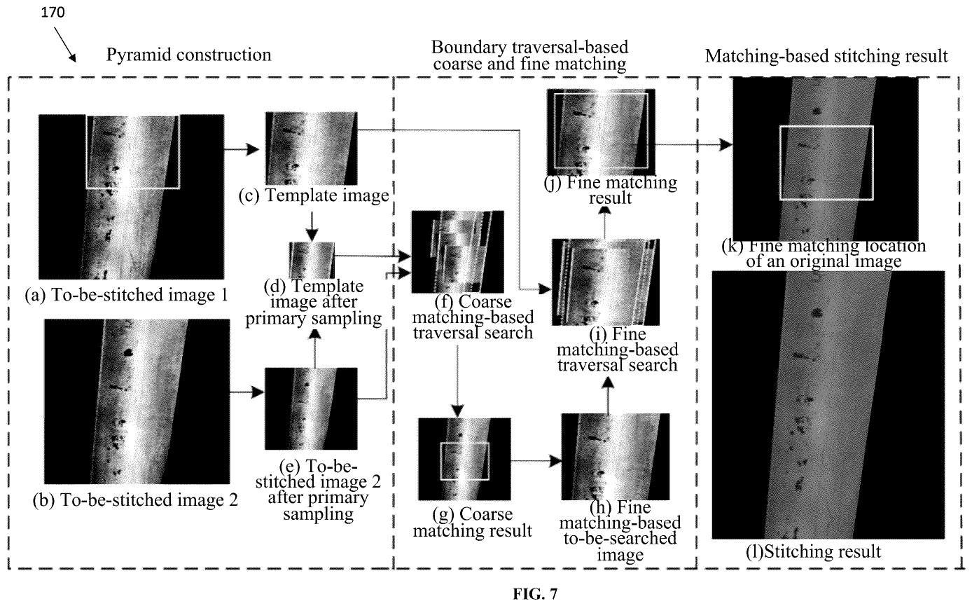

The NCC algorithm for grayscale images is time-consuming and poses a high requirement on image contrast, and therefore, an improved NCC algorithm for boundary search is adopted. As shown in the configuration 170 of FIG. 7, the following provides a specific implementation process of the improved NCC algorithm for boundary search.

The background-subtracted blade visible image is preprocessed with histogram equalization (for details, refer to Sand-Dust Degraded Image Enhancement Algorithm Based on Histogram Equalization and MSRCR [J], Wang Chunzhi, Niu Hongxia, Computer Engineering, 2022, 48(09): 223-229. DOI: 10.19678/j.issn.1000-3428.0062764), to improve the image contrast.

When two adjacent frames of images are stitched, the subsequent frame is used as the to-be-searched image, and a part is extracted from an overlapping part of the previous frame of image to serve as the template image (as shown in the white box in the to-be-stitched image 1 in FIG. 7). A two-level image pyramid is constructed for both the to-be-searched image and the template image using downsampling.

Matching is first performed on the top layer of the pyramid image based on the first boundary coordinate list. During matching, a matching region is formed by leftward and rightward expanding by 10 pixels with a blade right boundary of the top layer of a to-be-searched image as a center. The top layer of the template image is traversed in the matching region based on the blade right boundary, to find a correct matching location. A size of the top layer of the pyramid image is ¼ of that of the original image, so that computation during matching can be reduced.

After the initial optimal matching location is determined through top-layer image matching, in the to-be-searched image, a 6×6-pixel rectangular region centered at the initial optimal matching location is defined corresponding to a next layer of the pyramid layer. Similarly, traversing and searching are performed by using the blade right boundary as a center, to obtain the optimal matching location through fine matching. During traversal search-based matching, a matching speed is increased by performing NCC calculation through searching and matching along a blade boundary.

Finally, a pixel increment Q_{k,k-1} (namely, Q) between two adjacent frames of images is obtained based on the optimal matching location. After a previous frame (namely, (k−1)^{th} frame) of image is put at a pixel increment Q location of a next frame (namely, k^{th} frame) of image, two adjacent frames of blade visible images are stitched.

In step 7, as shown at block 114 in FIG. 1, a pixel increment when two corresponding adjacent frames of blade infrared images are stitched is calculated based on the relative displacement and the pixel increment when two adjacent frames of blade visible images are stitched.

In this embodiment, a specific calculation formula for the pixel increment when two adjacent frames of blade infrared images are stitched is as follows:

$${P}_{k , k - 1} = {Q}_{k , k - 1} + ( {h}_{k} - {h}_{k - 1} ) , \qquad ( 15 )$$

where
P_{k,k-1} represents a pixel increment when a k^{th} frame of background-subtracted blade infrared image and a k−1^{th} frame of background-subtracted blade infrared image are stitched; Q_{k,k-1} represents a pixel increment when a k^{th} frame of background-subtracted blade visible image and a k−1^{th} frame of background-subtracted blade visible image are stitched; represents the relative displacement during fine registration between the k^{th} frame of foreground mask visible image and foreground mask infrared image; and hₖ₋₁ represents a relative displacement between a k−1^{th} frame of foreground mask visible image and foreground mask infrared image.

In step 8, as depicted at block 116 in FIG. 1, two corresponding adjacent frames of background-subtracted blade infrared images are stitched based on the pixel increment when two adjacent frames of blade infrared images are stitched, to obtain an infrared panoramic image of the wind turbine blade.

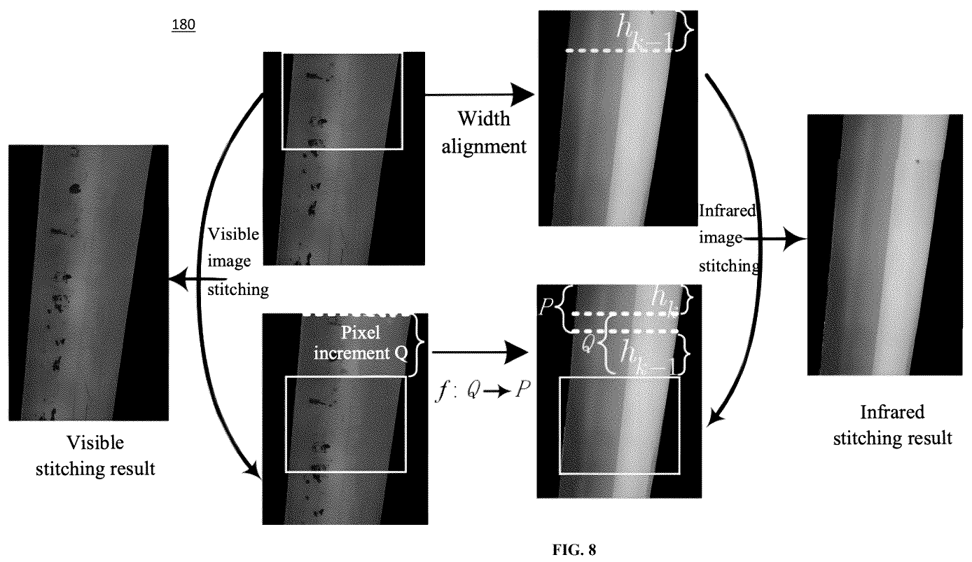

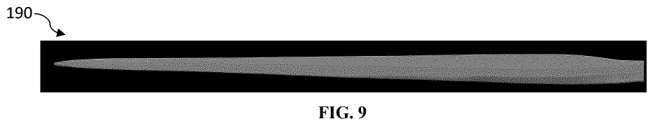

As shown in FIG. 8, the k−1^{th} frame of background-subtracted blade infrared image is put at a pixel increment P_{k,k-1} location of the k^{th} frame of background-subtracted blade infrared image based on the pixel increment P_{k,k-1} when two adjacent frames of blade infrared images are stitched, to stitch the k−1^{th} frame and the k^{th} frame of blade infrared images. The stitching result is stitched with a next frame (namely, k+1^{th} frame) of blade infrared image by using a same method, that is, an k+1^{th} frame of background-subtracted blade visible image is used as the to-be-searched image, and a part of an overlapping part (namely, a stitching result of the k−1^{th} frame and the k^{th} frame of blade visible images) of a corresponding visible image stitching result is used as a template image for next stitching, to calculate a corresponding pixel increment P through matching and mapping. The blade infrared images are stitched based on the pixel increment P, and steps 6 to 8 are performed repeatedly to obtain an infrared panoramic image of the wind turbine blade as shown in FIG. 9.

In another specific implementation of the present disclosure, alternatively, a pixel increment for each stitching may be first obtained during blade visible image stitching, that is, a pixel increment during stitching of a first frame and a second frame of blade visible images, a pixel increment during stitching between a stitching result of the first frame and the second frame of blade visible images and a third frame of blade visible image, a pixel increment during stitching between a previous stitching result (namely, a result obtained by stitching the stitching result between the first frame and the second frame of blade visible images and the third frame of blade visible image) and a fourth frame of blade visible image . . . ; then, a corresponding pixel increment during stitching between blade infrared images is calculated according to the step 7; and finally, two corresponding frames of blade infrared images are stitched according to the step 8.

### Embodiment 2

An embodiment of the present disclosure further provides an electronic device, where the electronic device includes a memory, a processor, and a computer program/instruction stored on the memory, where the processor executes the computer program/instruction to implement the panoramic stitching method for infrared images of a wind turbine blade in this embodiment of the present disclosure.

Although not shown, the electronic device includes the processor that is capable of performing various suitable actions and processing according to a program stored in a read-only memory (ROM) or a program loaded from a storage part to a random access memory (RAM). The processor may be a multi-core processor, or there may be a plurality of processors. In some embodiments, the processor may include a general-purpose main processor and one or more special coprocessors, for example, a central processing unit, a graphics processing unit (GPU), a neural processing unit (NPU), and a digital signal processor (DSP). Various programs and data required for operations of a device are further stored in the RAM. The processing unit, the ROM, and the RAM are connected to each other through a bus. An input/output (I/O) interface is also connected to the bus.

The processor and the memory are configured to execute a program/instruction stored in the memory. When the program/instruction is executed by a computer, the methods, steps, or functions described in the embodiments may be implemented.

Although not shown, an embodiment of the present disclosure further provides a computer-readable storage medium storing a computer program/instruction. When the computer program/instruction is executed by a processor, the panoramic stitching method for infrared images of a wind turbine blade in the embodiments of the present disclosure is implemented.

The readable medium includes both persistent, non-persistent, removable, and non-removable media, and storage of information may be implemented by any method or technology. The information may be a computer-readable instruction, a data structure, a module of a program, or other data. Examples of a computer storage medium include, but are not limited to, a phase-change random access memory (PRAM), a static random access memory (SRAM), a dynamic random access memory (DRAM), other types of RAMs, a ROM, an electrically erasable programmable read-only memory (EEPROM), a flash memory or another memory technology, a compact disc read-only memory (CD-ROM), a digital versatile disk (DVD) or another optical storage device, a magnetic cassette tape, and a magnetic tape disk storage device or another magnetic storage device or any other non-transmission medium, which can be configured to store information that can be accessed by a computing device. The computer-readable medium, as defined herein, excludes non-transitory computer-readable media (transitory media), such as modulated data signals and carrier waves.

Although not shown, an embodiment of the present disclosure further provides a computer medium product, including a computer program/instruction. When the computer program/instruction is executed by a processor, the panoramic stitching method for infrared images of a wind turbine blade in the embodiments of the present disclosure is implemented.

The above are merely specific implementations of the present disclosure, and the protection scope of the present disclosure is not limited thereto. Any modification or replacement easily conceived by those skilled in the art within the technical scope of the present disclosure should fall within the protection scope of the present disclosure.

What is claimed is:

1. A panoramic stitching method for infrared images of a wind turbine blade, wherein the stitching method comprises:
obtaining a plurality of frames of visible images and infrared images of the wind turbine blade, wherein each frame of visible image corresponds to each frame of infrared image, and two adjacent frames of images overlap each other;
performing coarse registration on each frame of visible image and infrared image to obtain an infrared image that is coarsely registered with the visible image;
separately performing background subtraction on a coarsely-registered visible image and a coarsely-registered infrared image to obtain a foreground mask visible image, a foreground mask infrared image, a background-subtracted blade visible image, and a background-subtracted blade infrared image;
performing fine registration on the foreground mask visible image and the foreground mask infrared image to obtain a relative displacement during the fine registration between the foreground mask visible image and the foreground mask infrared image;
stitching a plurality of frames of background-subtracted blade visible images to obtain a pixel increment when two adjacent frames of blade visible images are stitched;
calculating, based on the relative displacement and the pixel increment when two adjacent frames of blade visible images are stitched, a pixel increment when two corresponding adjacent frames of blade infrared images are stitched; and
stitching, based on the pixel increment when two adjacent frames of blade infrared images are stitched, two corresponding adjacent frames of background-subtracted blade infrared images, to obtain an infrared panoramic image of the wind turbine blade.

2. The panoramic stitching method for infrared images of a wind turbine blade according to claim 1, wherein before the obtaining a plurality of frames of visible images and infrared images of the wind turbine blade, the method comprises: adopting a Zhang's calibration method to separately perform monocular calibration on a visible light camera configured to acquire a visible image and an infrared thermal imaging camera configured to acquire an infrared image, to obtain an intrinsic matrix of the visible light camera, an intrinsic matrix of the infrared thermal imaging camera, a distortion correction parameter of the visible image, and a distortion correction parameter of the infrared image.

3. The panoramic stitching method for infrared images of a wind turbine blade according to claim 1, wherein the obtaining a plurality of frames of visible images and infrared images of the wind turbine blade is specifically implemented as follows:
locking a to-be-inspected wind turbine blade;
carrying a visible light camera and an infrared thermal imaging camera on an unmanned aerial vehicle; and
controlling the unmanned aerial vehicle to perform rectilinear flight and acquire an image along a single blade and in parallel to a blade surface.

4. The panoramic stitching method for infrared images of a wind turbine blade according to claim 1, wherein the performing coarse registration on each frame of visible image and infrared image comprises:
performing an un-distortion operation on the visible image based on an intrinsic matrix of a calibrated visible light camera and a distortion correction parameter of the visible image;
performing an un-distortion operation on the infrared image based on an intrinsic matrix of a calibrated infrared thermal imaging camera and a distortion correction parameter of the infrared image;
calculating a registration transformation matrix and an offset based on an undistorted visible image and an undistorted infrared image, wherein a calculation formula for the registration transformation matrix is as follows:
$${R}_{C} = [ \begin{matrix}{δ}_{s} & 0 \\ 0 , & {δ}_{s}\end{matrix} ] , {δ}_{s} = \frac{{B}_{i}^{V} - {B}_{i - 1}^{V}}{{B}_{i}^{l} - {B}_{i - 1}^{l}} ,$$
wherein
R_{C} represents the registration transformation matrix, δₛ represents a scaling factor,
$${B}_{i}^{V} and {B}_{i - 1}^{V}$$
respectively represent coordinates, in a horizontal direction or a vertical direction of the visible image, of centers of two adjacent black squares i and i−1 in a chessboard calibration board, and
$${B}_{i}^{l} and {B}_{i - 1}^{l}$$
respectively represent coordinates, in a horizontal direction or a vertical direction of the infrared image, of the centers of the two adjacent black squares i and i−1 in the chessboard calibration board; and the chessboard calibration board is located in front of the visible light camera and the infrared thermal imaging camera;
a calculation formula for the offset is as follows:
$${x}_{d} = {x}_{vis} - {x}_{inf} , {y}_{d} = {y}_{vis} - {y}_{inf} ,$$
wherein
x_{d} and y_{d} represent offsets of the infrared image in the horizontal direction and the vertical direction, and (xᵥᵢₛ, yᵥᵢₛ) and (x_{inf}, y_{inf}) respectively represent pixel coordinates, in the visible image and the infrared image, of a center of any square in the chessboard calibration board; and
calculating, based on the registration transformation matrix and the offset, the infrared image that is coarsely registered with the visible image, and a specific formula is as follows:
$$[ \begin{matrix}{Inf}_{ix}^{′} \\ {Inf}_{iy}^{′}\end{matrix} ] = [ \begin{matrix}{δ}_{s} & 0 \\ 0 & {δ}_{s}\end{matrix} ] [ \begin{matrix}{Inf}_{i x} \\ {Inf}_{iy}\end{matrix} ] + [ \begin{matrix}{x}_{d} \\ {y}_{d}\end{matrix} ] ,$$
wherein
(Infᵢₓ, Inf_{iy}) represents pixel coordinates of the undistorted infared image, and
$$( {Inf}_{ix}^{′} , {Inf}^{′} )$$
represents pixel coordinates of the infrared image that is coarsely registered with the visible image.

5. The panoramic stitching method for infrared images of a wind turbine blade according to claim 1, wherein the separately performing background subtraction on a coarsely-registered visible image and a coarsely-registered infrared image comprises:
separately performing background segmentation on the coarsely-registered visible image and the coarsely-registered infrared image to obtain the foreground mask visible image and the foreground mask infrared image;
separately performing an edge contour smoothing operation on the foreground mask visible image and the foreground mask infrared image; and
separately setting foreground RGB channel pixels of a smoothed foreground mask visible image to 1, and then multiplying the smoothed foreground mask visible image with the foreground RGB channel pixel set to 1 with the visible image to obtain the background-subtracted blade visible image; and separately setting foreground RGB channel pixels of a smoothed foreground mask infrared image to 1, and then multiplying the smoothed foreground mask infrared image with the foreground RGB channel pixel set to 1 with the coarsely-registered infrared image to obtain the background-subtracted blade infrared image.

6. The panoramic stitching method for infrared images of a wind turbine blade according to claim 1, wherein the performing fine registration on the foreground mask visible image and the foreground mask infrared image comprises:
separately performing edge detection on the foreground mask visible image and the foreground mask infrared image to obtain a blade edge visible image and a blade edge infrared image;
separately performing boundary extraction on the blade edge visible image and the blade edge infrared image to obtain a first boundary coordinate list and a second boundary coordinate list, wherein the first boundary coordinate list is a boundary coordinate list of the blade edge visible image, and the second boundary coordinate list is a boundary coordinate list of the blade edge infrared image;
calculating a first width information list based on the first boundary coordinate list, and calculating a second width information list based on the second boundary coordinate list; and
calculating, based on the first width information list and the second width information list, the relative displacement during the fine registration between the foreground mask visible image and the foreground mask infrared image, wherein a specific calculation formula is as follows:
$${h}_{k} = {y}_{i}^{″} , {y}_{i}^{″} ← min \vert {w}_{i}^{″} - {w}_{0}^{′} \vert ,$$
wherein
hₖ represents a relative displacement during fine registration between a k^{th} frame of foreground mask visible image and foreground mask infrared image,
$${w}_{0}^{′}$$
represents a width of an uppermost part in the first width information list,
$${w}_{i}^{″}$$
represents a width of an i^{th} row in the second width information list, and
$${y}_{i}^{″}$$
represents a vertical coordinate of an i^{th} row in the second width information list.

7. The panoramic stitching method for infrared images of a wind turbine blade according to claim 1, wherein a specific calculation formula for the pixel increment when two adjacent frames of blade infrared images are stitched is as follows:
$${P}_{k , k - 1} = {Q}_{k , k - 1} + ( {h}_{k} - {h}_{k - 1} ) ,$$
wherein
P_{k,k-1} represents a pixel increment when a k^{th} frame of background-subtracted blade infrared image and a k−1^{th} frame of background-subtracted blade infrared image are stitched;
Q_{k,k-1} represents a pixel increment when a k^{th} frame of background-subtracted blade visible image and a k−1^{th} frame of background-subtracted blade visible image are stitched; hₖ represents the relative displacement during fine registration between the k^{th} frame of foreground mask visible image and foreground mask infrared image; and hₖ₋₁ represents a relative displacement between a k−1^{th} frame of visible light foreground mask image and foreground mask infrared image.

8. An electronic device, comprising a memory, a processor, and a computer program/instruction stored on the memory, wherein the processor executes the computer program/instruction to implement the panoramic stitching method for infrared images of a wind turbine blade according to claim 1.

9. A non-transitory computer-readable storage medium on which a computer program/instruction is stored, wherein when the computer program/instruction is executed by a processor, the panoramic stitching method for infrared images of a wind turbine blade according to claim 1 is implemented.

10. The panoramic stitching method for infrared images of a wind turbine blade according to claim 2, wherein a specific calculation formula for the pixel increment when two adjacent frames of blade infrared images are stitched is as follows:
$${P}_{k , k - 1} = {Q}_{k , k - 1} + ( {h}_{k} - {h}_{k - 1} ) ,$$
wherein
P_{k,k-1} represents a pixel increment when a k^{th} frame of background-subtracted blade infrared image and a k−1^{th} frame of background-subtracted blade infrared image are stitched; Q_{k,k-1} represents a pixel increment when a k^{th} frame of background-subtracted blade visible image and a k−1^{th} frame of background-subtracted blade visible image are stitched; hₖ represents the relative displacement during fine registration between the k^{th} frame of foreground mask visible image and foreground mask infrared image; and hₖ₋₁ represents a relative displacement between a k−1^{th} frame of visible light foreground mask image and foreground mask infrared image.

11. The panoramic stitching method for infrared images of a wind turbine blade according to claim 3, wherein a specific calculation formula for the pixel increment when two adjacent frames of blade infrared images are stitched is as follows:
$${P}_{k , k - 1} = {Q}_{k , k - 1} + ( {h}_{k} - {h}_{k - 1} ) ,$$
wherein
P_{k,k-1} represents a pixel increment when a k^{th} frame of background-subtracted blade infrared image and a K−1^{th} frame of background-subtracted blade infrared image are stitched;
Q_{k,k-1} represents a pixel increment when a k^{th} frame of background-subtracted blade visible image and a k−1^{th} frame of background-subtracted blade visible image are stitched; hₖ represents the relative displacement during fine registration between the k^{th} frame of foreground mask visible image and foreground mask infrared image; and hₖ₋₁ represents a relative displacement between a k−1^{th} frame of visible light foreground mask image and foreground mask infrared image.

12. The panoramic stitching method for infrared images of a wind turbine blade according to claim 4, wherein a specific calculation formula for the pixel increment when two adjacent frames of blade infrared images are stitched is as follows:
$${P}_{k , k - 1} = {Q}_{k , k - 1} + ( {h}_{k} - {h}_{k - 1} ) ,$$
wherein
P_{k,k-1} represents a pixel increment when a k^{th} frame of background-subtracted blade infrared image and a k−1^{th} frame of background-subtracted blade infrared image are stitched;
Q_{k,k-1} represents a pixel increment when a k^{th} frame of background-subtracted blade visible image and a k−1^{th} frame of background-subtracted blade visible image are stitched; hₖ represents the relative displacement during fine registration between the k^{th} frame of foreground mask visible image and foreground mask infrared image; and hₖ₋₁ represents a relative displacement between a k−1^{th} frame of visible light foreground mask image and foreground mask infrared image.

13. The panoramic stitching method for infrared images of a wind turbine blade according to claim 5, wherein a specific calculation formula for the pixel increment when two adjacent frames of blade infrared images are stitched is as follows:
$${P}_{k , k - 1} = {Q}_{k , k - 1} + ( {h}_{k} - {h}_{k - 1} ) ,$$
wherein
P_{k,k-1} represents a pixel increment when a k^{th} frame of background-subtracted blade infrared image and a K−1^{th} frame of background-subtracted blade infrared image are stitched;
Q_{k,k-1} represents a pixel increment when a k^{th} frame of background-subtracted blade visible image and a k−1^{th} frame of background-subtracted blade visible image are stitched; hₖ represents the relative displacement during fine registration between the k^{th} frame of foreground mask visible image and foreground mask infrared image; and hₖ₋₁ represents a relative displacement between a K−1^{th} frame of visible light foreground mask image and foreground mask infrared image.

14. The panoramic stitching method for infrared images of a wind turbine blade according to claim 6, wherein a specific calculation formula for the pixel increment when two adjacent frames of blade infrared images are stitched is as follows:
$${P}_{k , k - 1} = {Q}_{k , k - 1} + ( {h}_{k} - {h}_{k - 1} ) ,$$
wherein
P_{k,k-1} represents a pixel increment when a k^{th} frame of background-subtracted blade infrared image and a k−1^{th} frame of background-subtracted blade infrared image are stitched;
Q_{k,k-1} represents a pixel increment when a k^{th} frame of background-subtracted blade visible image and a k−1^{th} frame of background-subtracted blade visible image are stitched; hₖ represents the relative displacement during fine registration between the k^{th} frame of foreground mask visible image and foreground mask infrared image; and hₖ₋₁ represents a relative displacement between a k−1^{th} frame of visible light foreground mask image and foreground mask infrared image.

15. An electronic device, comprising a memory, a processor, and a computer program/instruction stored on the memory, wherein the processor executes the computer program/instruction to implement the panoramic stitching method for infrared images of a wind turbine blade according to claim 2.

16. An electronic device, comprising a memory, a processor, and a computer program/instruction stored on the memory, wherein the processor executes the computer program/instruction to implement the panoramic stitching method for infrared images of a wind turbine blade according to claim 3.

17. An electronic device, comprising a memory, a processor, and a computer program/instruction stored on the memory, wherein the processor executes the computer program/instruction to implement the panoramic stitching method for infrared images of a wind turbine blade according to claim 4.

18. An electronic device, comprising a memory, a processor, and a computer program/instruction stored on the memory, wherein the processor executes the computer program/instruction to implement the panoramic stitching method for infrared images of a wind turbine blade according to claim 5.

19. An electronic device, comprising a memory, a processor, and a computer program/instruction stored on the memory, wherein the processor executes the computer program/instruction to implement the panoramic stitching method for infrared images of a wind turbine blade according to claim 6.

20. An electronic device, comprising a memory, a processor, and a computer program/instruction stored on the memory, wherein the processor executes the computer program/instruction to implement the panoramic stitching method for infrared images of a wind turbine blade according to claim 7.
